(19) United States
(12) Patent Application Publication
(10) Pub. No.: US 2026/0154946 A1
(43) Pub. Date: Jun. 4, 2026

(54) RETRAINING FROM FALSE ALARMS WITHIN A BASE SECURITY USECASE

(71) Applicant: TurbineOne, Inc, San Francisco, CA (US)

(72) Inventors: Tyler Moore, Colorado Springs, CO (US); Daniel Hebb, San Diego, CA (US); Joshua Harrison, Boulder, CO (US); Sandeep Mittal, Garner, NC (US)

(21) Appl. No.: 18/966,123

(22) Filed: Dec. 3, 2024

(51) Int. Cl. G06V 10/774

(52) U.S. Cl. CPC G06V 10/774

(57) ABSTRACT

A security system detects objects using a machine learning model. At least one classifier head may be suffixed to the machine learning model. A classifier head is configured to determine a likelihood that the output of the machine learning model is accurate. Using the classifier head, the security system can determine whether to pass along the output of the machine learning model to a client device. The user can provide feedback on the accuracy of that output, which can then be used to re-train the classifier head. The security system may determine when to re-train the machine learning model based on an output of the classifier head. The security system may re-train the machine learning model using a subsampling of the original training dataset and an updated dataset that incorporates runtime sensor data and corresponding user feedback of the machine learning model's output.

### TECHNICAL FIELD

The present disclosure relates to security systems. In particular, the present disclosure relates to machine learning-driven object detection in security systems.

### BACKGROUND

Security systems are critical to detecting real-time threats to safety. Machine learning can enable automated object detection. However, machine learning models may not be as reliable as a human in accurately identifying security threats. To remedy this inaccuracy, machine learning models can be re-trained to improve accuracy. Re-training, however, is very processor and time intensive. A model can take hours to re-train, and in that time, security threats are being incorrectly identified and in turn, the safety of individuals and valuable property are at risk. Thus, re-training a machine learning model sufficient times to maintain accuracy for detecting real-time security threats is challenging because of the large amount of time needed to re-train the model.

### SUMMARY

A security system implements an object detection model and suffixes one or more classifier heads to the model. The security system leverages the classifier heads to determine the accuracy of the object detection model's outputs. The security system uses user feedback to iteratively and incrementally re-train the classifier heads. The re-training may occur in real time (e.g., within a minute of receiving user feedback and creating a labeled data point). In conventional security systems, machine learning models for object detection are re-trained infrequently and thus, produce inaccurate detection results that may endanger individuals or property.

A method, non-transitory computer-readable storage medium, and computer system are disclosed for receiving, from a client device, a first user feedback indicating an accuracy of a first output of an object detection model. The object detection model is trained to detect an object within a given image received from a sensor. The first output is associated with a first input image. A classifier head is trained using the first user feedback. The classifier head is configured to determine a likelihood that a given output of the object detection model meets a threshold accuracy. In response to determining, using the classifier head, that a second output of the object detection model meets the threshold accuracy, a notification is caused to be generated at the client device. The notification includes a request for a second user feedback indicating an accuracy of the second output associated with a second input image. The classifier head is re-trained using the second user feedback. In response to determining that the classifier head has classified a threshold number of the object detection model outputs as meeting the threshold accuracy, the object detection model is re-trained using image data labeled based on a plurality of user feedback. The image data is received from the sensor.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a block diagram of a system environment in which a security system operates, in accordance with one embodiment.

FIG. 2 depicts a block diagram of the security system of FIG. 1, in accordance with one embodiment.

FIG. 3 shows a block diagram of a process for re-training machine learning models of the security system of FIG. 1, in accordance with one embodiment.

FIG. 4 depicts graphical user interfaces that include notifications generated by the security system of FIG. 1, in accordance with one embodiment.

FIG. 5 depicts a flowchart of a process for re-training machine learning models of the security system of FIG. 1, in accordance with one embodiment.

FIG. 6 is a block diagram illustrating components of an example machine able to read instructions from a machine-readable medium and execute them in a processor (or controller).

### DETAILED DESCRIPTION

Aspects of the present disclosure relate to machine learning-driven object detection. A security system implements an object detection model and suffixes one or more classifier heads to the model. The classifier heads assess the accuracy of the object detection model's outputs. The security system leverages the classifier heads to determine whether to provide the object detection model's outputs to a client device. The security system uses user feedback on whether outputs were false positives (i.e., the model determined that a particular object was depicted in an image or video, but the user indicates that no such object was depicted). In conventional security systems, machine learning models are often re-trained infrequently because the systems are passing time to accumulate enough data for re-training the model or cannot afford to expend processor resources or time to frequently re-train the model. This can sacrifice detection accuracy, which can be critical in security systems where a person or property's safety is at risk.

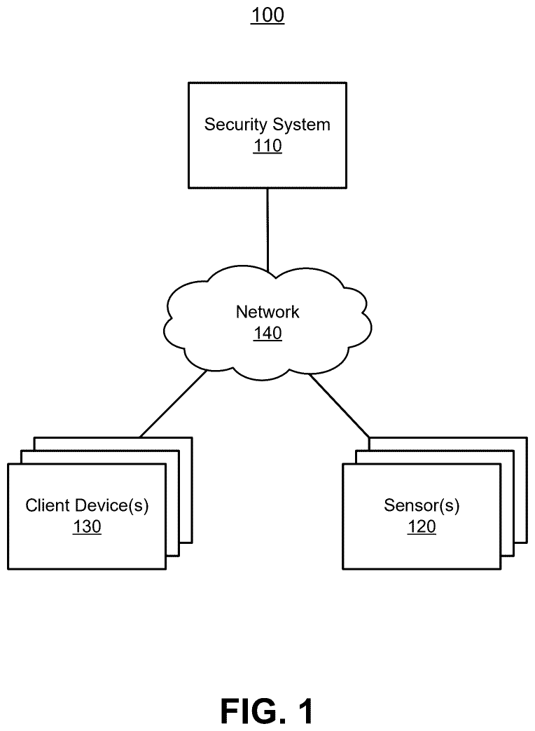

FIG. 1 illustrates a block diagram of a system environment 100 in which a security system 110 operates, in accordance with one embodiment. The system environment 100 includes a security system 110, sensor(s) 120, client device(s) 130, and a network 140. The system environment 100 may have alternative configurations than shown in FIG. 1, including different, fewer, or additional components.

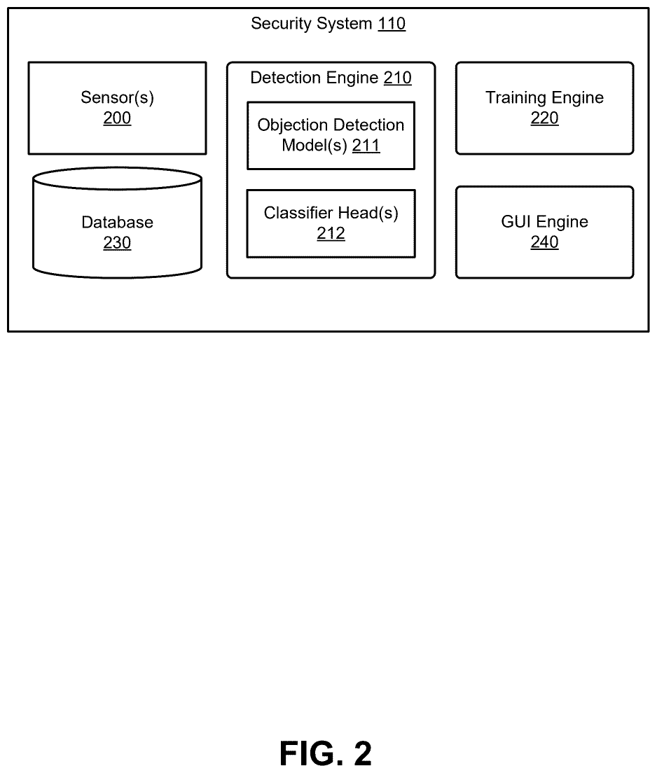

The security system 110 implements machine learning-driven object detection. The security system 110 may reside on a remote server communicatively coupled to the client device(s) 130. Although the security system 110 is depicted as remote from the client device(s) 130, in alternative embodiments, the security system 110 may reside on the client device(s) 130 and be executed from the client device(s) 130. Although the security system 110 is described as being applied to security uses, the machine learning-driven object detection of the security system 110 may be applied to non-security uses involving object detection. The security system 110 is described further with respect to the description of FIG. 2.

The sensor(s) 120 capture image data that may depict potential security threats. The sensor(s) 200 can include an imaging camera, infrared camera, depth camera, or any suitable optical sensor for capturing image data. The sensor(s) 120 may be co-located with other components of the security system 110 or located remotely (e.g., a camera located on a satellite that transmits the captured images to a ground-based remote server). The image data may include video or images. In some embodiments, the sensor(s) 120 may capture non-image data that may indicate a potential security threat. For example, the sensor(s) 120 may include a microphone that captures the noise from loading a firearm. The security system 110 may train a machine learning model to detect activity or objects from non-image data (e.g., a machine learning model trained to detect a firearm from noises caused from interacting with the firearm).

A client device, such as the client device(s) 130, may be a personal computer (PC), a tablet PC, a smartphone, or any suitable device capable of executing instructions that specify actions to be taken by that device. The client device(s) 130 may include a processor (e.g., a central processing unit (CPU), a graphics processing unit (GPU), a digital signal processor (DSP), one or more application specific integrated circuits (ASICs), one or more radio-frequency integrated circuits (RFICs), or any combination of these), a memory, a user interface to receive user inputs or provide outputs to the user (e.g., a visual display interface including a touch enabled screen, a keyboard, microphone, speakers, etc.). The visual interface may include a software driver that enables displaying user interfaces on a screen (or display).

The network 140 may serve to communicatively couple the security system 110, the sensor(s) 120, and the client device(s) 130. In some embodiments, the network 140 includes any combination of local area and/or wide area networks, using wired and/or wireless communication systems. The network 140 may use standard communications technologies and/or protocols. For example, the network 306 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 306 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 140 may be encrypted using any suitable technique or techniques.

FIG. 2 depicts a block diagram of the security system 110 of FIG. 1, in accordance with one embodiment. The security system 110 includes sensor(s) 200, a detection engine 210, a training engine 220, a database 230, and a graphical user interface (GUI) engine 240. The sensor(s) 200 may be similar to the sensor(s) 120. The detection engine 210, the training engine 220, and the GUI engine 240 may be software modules executed on a computer (e.g., a remote server or a client device). The security system 110 may include additional, fewer, or different components than depicted in FIG. 2. For example, the sensor(s) 200 may be excluded from the security system 110 and instead, the security system 110 may be communicatively coupled to third party sensors. The security system 110 may be executed across two or more computer systems. For example, an object detection model may be executed on a remote server while a classifier head may be executed on a client device.

The detection engine 210 detects security threats within image data. The detection engine 210 includes one or more object detection model(s) 211 and one or more classifier head(s) 212. Although depicted together, the object detection model(s) 211 and the classifier head(s) 212 may be executed on separate computer systems. For example, an object detection model 211 may be executed on a remote server while a classifier head that receives the output of the object detection model 211 is executed on a client device 130. The object detection model 211 may detect non-objects in addition or alternative to objects. For example, an object detection model 211 may be trained to detect living entities (e.g., animals or humans) or an activity happening over time (e.g., a weather phenomenon or a criminal activity).

The object detection model(s) 211 and the classifier head(s) 212 may be machine learning models. Example models used by the detection engine 210 include text classifiers, computer vision models, diagnostic models, transformers, autoencoders, or any suitable trained machine learning model.

The detection engine 210 may determine a context parameter for selecting a particular classifier head for application using user feedback. The context parameter may characterize one or more of images input to the object detection model or user feedback of the output of the object detection model. Examples of context parameter include a type of client device, an environment type depicted in the images input into the object detection model, or a client application for which the output of the object detection model is used. A client application may be a software application executable by a client device 130. Each of the classifier heads may be trained to specialize in determining the accuracy of the object detection model 211 with respect to a particular context parameter. For example, a first classifier head specializing in determining the accuracy of the object detection model 211 when detecting objects made by a particular manufacturer may be trained by using user feedback on images of the object made by the particular manufacturer.

The detection engine 210 may receive the context parameter for selecting a particular classifier head from a user input provided through the client device. The detection engine 210 may receive from a client device 130 a selection of a context parameter. The detection engine 210 may provide a list of possible context parameters from which the user may select one or more context parameter. The detection engine 210 may determine the context parameter automatically. For example, the detection engine 210 may receive a hardware identifier with the user feedback, where the hardware identifier specifies a type of client device that the training engine 220 uses as the context parameter.

The training engine 220 may train a model based on one or more training algorithms. Examples of training algorithms may include mini-batch-based stochastic gradient descent (SGD), gradient boosted decision trees (GBDT), support vector machine (SVM), neural networks, logistic regression, naïve Bayes, memory-based learning, random forests, decision trees, bagged trees, boosted trees, or boosted stumps.

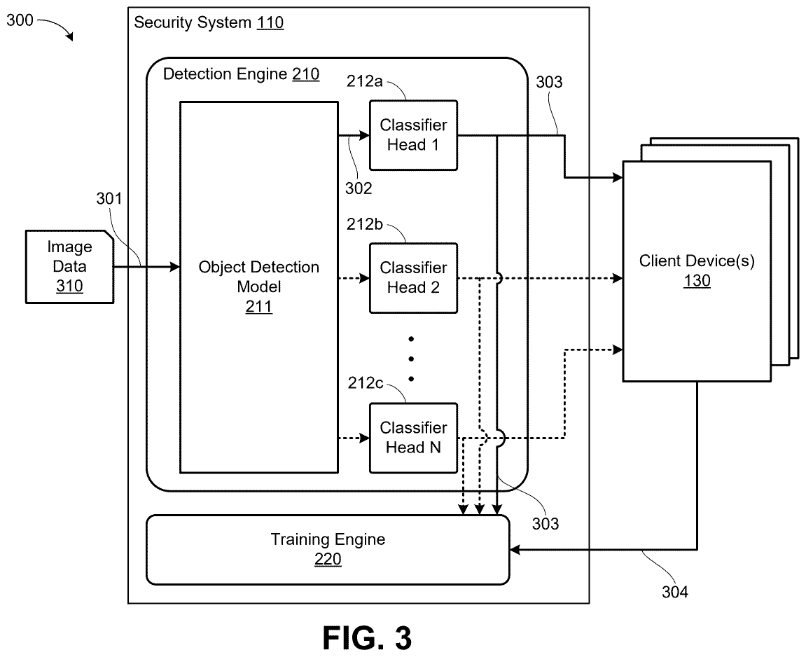

The training engine 220 may train a classifier head using user feedback data associated with a particular context parameter. For example, the training engine 220 may train the classifier head 212a (e.g., see FIG. 3) using user feedback from a first client device of the client devices 130 and train the classifier head 212b using user feedback from a second client device of the client devices 130. In another example, the training engine 220 may train the classifier head 212a using user feedback for object detection for a camera detecting smoke or fire in a kitchen (i.e., a first client application) and train the classifier head 212b for object detection in satellite images for an emergency weather service detecting wildfire smoke (i.e., a second client application).

In some embodiments, the detection engine 210 may apply two or more classifier heads 212 to the output of the object detection model 211 and provide the outputs of those two or more classifier heads 212 to the client device(s) 130. A user may provide feedback indicating the accuracy for each of the outputs of those two or more classifier heads 212. Using the user feedback, the detection engine 210 may determine one of the classifier heads 212 for which the user is indicating a higher accuracy. The detection engine 210 may apply that classifier head 212 rather than other classifier heads 212 until the detection engine 210 begins to receive negative user feedback of the detection accuracy. For example, the detection engine 210 may determine that the accuracy has fallen below a threshold accuracy or that the ratio of positive user feedback to negative user feedback (e.g., positive feedback meeting a threshold accuracy level) for the last N>0 instances of user feedback has fallen below a particular threshold ratio. In response, the detection engine 210 may return to applying two or more classifier heads 212 to the output of the object detection model 211 and determine which of the two or more classifier heads 212 is garnering the most positive feedback (or satisfying some other metric for accuracy).

The output of the object detection model 211 may be transmitted to one or more of the client device(s) 130 based on the output of a classifier head 212. For example, in response to the first classifier head 212a determining that the likelihood that the object detection model output meets a threshold accuracy, the detection engine 210 transmits the object detection model output to a client device. In response to the first classifier head 212a determining that the likelihood that the object detection model output does not meet the threshold accuracy, the detection engine 210 does not transmit the object detection model output to the client device. The detection engine 210 may, rather than transmitting the object detection model output that does not satisfy the threshold accuracy, store the output as a negative example for subsequent re-training of the object detection model 211. The detection engine 210 may store the output with a label indicating that the object was not detected in the image input into the object detection model 211.

The training engine 220 can train or re-train the object detection model(s) 211 or classifier head(s) 212. The training engine 220 may use subsampling of various training datasets to re-train an object detection model. For example, the training engine 220 may subsample the original training dataset and a dataset including data from runtime, which enables the re-trained object detection model to learn object detection from new data while not forgetting what the model has learned from old data.

Advantages of the present security system 110 include increasing the accuracy of a trained object detection model and reducing the time needed to re-train the object detection model. Moreover, the security system 110 can avoid catastrophic forgetting, which is a tendency of a machine learning model to forget previously learned information upon learning new information. When affected by catastrophic forgetting, a machine learning model may lose an ability to perform on previously learned tasks when it is trained on new tasks. Hence, conventional security systems that retrain models with new data may cause the models to deteriorate when retraining due to catastrophic forgetting. By re-training an object detection model with a subsample of the original training dataset and a dataset including data from runtime, the present security system 110 prevents the object detection model from deteriorating in its accuracy.

The training engine 220 may label outputs of the object detection model 211 as a positive or negative example based on the user feedback. The user feedback may be a binary value associated with a successful or unsuccessful detection. A classifier head trained with these binary labels may predict whether a given output of the object detection model 211 is successful or unsuccessful for that particular context parameter. Alternatively, the user feedback may reflect a percentage of accuracy (e.g., the user specifies 50% accurate if the output of the object detection model 211 outputs an image with a boundary box over half the object the model was trained to detect). The training engine 220 may label outputs of the object detection model 211 with the percentage of accuracy indicated by the user feedback. A classifier head trained with non-binary labels may predict a corresponding non-binary likelihood whether a given output of the object detection model 211 is successful or unsuccessful.

One or more of the classifier heads 212 may be a hardware-aware classifier, which is a classifier trained depending on a type of hardware at which the object detections are used or where the classification of the classifier head executed. The training engine 220 may determine a type of hardware of a client device based on a hardware identifier of the client device. The training engine 220 may train a classifier head using one of a full precision training, half precision training, 8-bit precision, or mixed precision training based on a hardware identifier of the client device. For example, the training engine 220 may determine that a classifier head is being or is to be executed on a field programmable gate array (FPGA) device based on a hardware identifier of the FPGA and in response, the training engine 220 uses a mixed precision training to train the classifier head. In another example, the training engine 220 determines that a classifier head is executed on a portable computer without a graphics processing unit and in response, the training engine 220 retrains using a slower central processing unit-based approach. The training engine 220 may perform this determination by detecting the absence of tensor-enabled hardware on the portable computer.

The training engine 220 receives user feedback from the client device(s) 130. The user feedback indicates an accuracy of the output of the object detection model 211. The user feedback may be binary (e.g., a thumbs up or thumbs down) or a value within a discrete range (e.g., a star rating or a percentage). The amount of negative user feedback may decrease with the inclusion of the classifier head trained to filter out outputs of the object detection model 211 that are likely inaccurate. The training engine 220 may use the user feedback to re-train a classifier head 212. In some embodiments, the training engine 220 can automatically re-train a classifier head each time user feedback is received. This re-training may happen in substantially real time. For example, the training engine 220 can begin re-training the first classifier head 212a within a minute of receiving user feedback on the output of the object detection model 211 that the first classifier head 212a had determined as meeting a threshold accuracy.

The training engine 220 may monitor the outputs of the classifier heads 212 to determine when to re-train the object detection model 211. The training engine 220 may determine that the object detection model 211 is performing to a sufficient degree of accuracy over time based on the number of classifier head outputs indicating the object detection model 211 outputs meet a threshold accuracy. For example, the training engine 220 re-trains the object detection model 211 in response to determining that at least 80% of the last fifty outputs of each of the classifier heads 212 has satisfies an accuracy threshold. In the case that different classifier heads have different accuracy thresholds, the training engine 220 may determine to re-train the object detection model 211 in response to determining that a threshold percentage of some number of recent outputs of each of the classifier heads satisfies its respective accuracy threshold. Alternative or additional metrics for determining when to re-train the object detection model 211 may be used. For example, a minimum number of consecutive model outputs that meet an accuracy threshold, a minimum number of model outputs that both the classifier head and user feedback indicates are accurate, or any suitable metric indicating the accuracy of the object detection model 211. Metrics for determining when to re-train the object detection model 211 may be based on the outputs of a single classifier head or a combination of outputs of two or more classifier heads.

The training engine 220 can re-train the object detection model 211 using data from one or more of the original training dataset (i.e., without any user feedback) or an updated training dataset with runtime data labeled according to user feedback. For example, the training engine 220 can re-train the object detection model 211 with a dataset that is composed of in part with data from the original training dataset and in part from the updated training dataset. The original dataset may be a predefined dataset. The training engine 220 can generate the updated training dataset by labeling image data received from sensors (e.g., the sensor(s) 120 or the sensor(s) 200) using labels based on user feedback. For example, the training engine 220 labels an image of a person detected by an object detection model configured to detect people with a “person” label because the user feedback indicated that the detection was accurate. In another example, the training engine 220 labels an image with a person that was not detected by the object detection model with a “person” label because the user feedback indicated that the detection was inaccurate. By using both the original training data and an updated training dataset, the training engine 220 can subsample the original training data while incorporating new data. In this way, the training engine 220 trains the object detection model 211 on new data while enabling the model 211 to remember old data.

The training engine 220 may re-train the object detection model 211 using a k-fold cross validation. The training engine 220 may subsample from one or more of the original training dataset or an updated training set and re-train the object detection model 211 using two or more permutations of subsampled data. For example, the training engine 220 can create three different training datasets, each training dataset having a portion of labeled data from the original training dataset and the updated training set, wherein the updated training set includes data received from a sensor during runtime that is labeled according to user feedback. The training engine 220 can re-train the object detection model 211 using each of the three different training datasets and select one of the three re-trained versions of the object detection model 211 to use during runtime. The training engine 220 may select the re-trained version having the highest accuracy.

The training engine 220 can re-train the object detection model 211 using an initial set of weights different from the initial set of weights originally used to train the object detection model. The training engine 220 may use the last best weights to re-train the object detection model. The training engine 220 may identify the last best weights by storing records of weights of the object detection model mapped to an accuracy of one or more outputs produced by the object detection model 211 with the respective weights. The training engine 220 may access, from the records, which weights are associated with the highest accuracy of outputs of the object detection model 211. The training engine 220 may begin re-training the object detection model using the last best weights instead of using the initial set of weights used to train the object detection model.

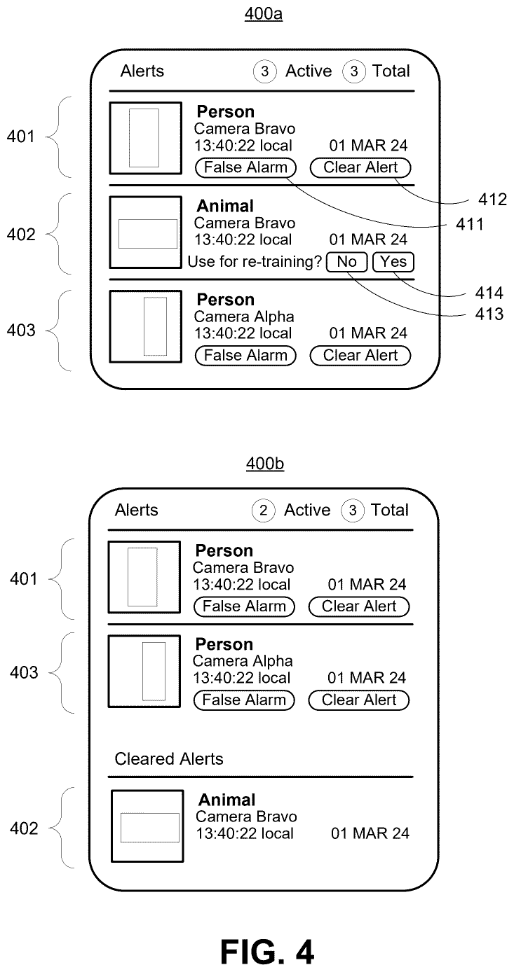

The database 230 can store training datasets, image data transmitted by the sensor(s) 200, or user feedback received from the client device(s) 130. The graphical user interface (GUI) engine 240 may generate a GUI through which a user can receive notifications of object detections made by the security system 110 or can provide feedback on the accuracy of the object detections. The GUI engine 240 may update generated GUIs in response to user interactions. Examples of generating and updating GUIs are depicted in FIG. 4.

FIG. 3 shows a block diagram of a process 300 for re-training machine learning models of the security system 110 of FIG. 1, in accordance with one embodiment. The process 300 may include additional, fewer, or alternative operations than described in the description of FIG. 3. While components of the security system 110 are depicted in FIG. 3 as being executed from a remote server (i.e., separate from the client device(s) 130), one or more of the components may be located at and executed from the client device(s) 130. For example, each client device 130 may host and execute a respective classifier head 212 rather than the classifier heads 212 being executed on a remote server.

The security system 110 receives 301 image data 310. The image data 310 is input into the object detection model 211 of the detection engine 210. The output of the object detection model 211 indicates whether a particular object was depicted in the image data 310. The output of the object detection model 211 is transmitted 302 to a first classifier head 212a of the classifier head(s) 212. The first classifier head 212a determines a likelihood that the output of the object detection model 211 is accurate. If the output meets an accuracy threshold, the detection engine 210 causes the output of the object detection model 211 to be transmitted 303 the client device(s) 130. The output is also transmitted 303 to the training engine 220 for re-training one or more of the object detection model 211 or the classifier head(s) 212 (e.g., the first classifier head 212a). The security system 110 receives 304 user feedback from the client device(s) 130 indicating whether the output of the object detection model 211 was a false positive. The training engine 220 may label the output of the object detection model 211 according to the received 304 user feedback and use the labeled data to re-train a machine learning model of the detection engine 210. Although not depicted, the received 304 user feedback or the labeled data may be stored in the database 230.

Although not depicted, the detection engine 210 may operate before the classifier heads 212 have been trained. That is, the detection engine 210 may detect a particular object depicted within the image data 310 with the object detection model 211 and provide the output of the object detection model 211 directly to the client device(s) 130. The output of the object detection model 211 is not input to a classifier head 212 when none of the classifier heads have been trained yet. The training engine 220 receives user feedback of the output direct from the object detection model 211 to train a classifier head.

The detection engine 210 may determine to apply a first classifier head 212a to the output of the object detection model 211 based on a context parameter in which the first classifier head 212a specializes (i.e., is trained for that context parameter). For example, the first classifier head 212a may be specialized for a particular type of client device after the security system 110 has trained the classifier head 212a on feedback provided solely or primarily from that type of client device. In another example, the first classifier head 212a may be specialized for a particular environment type after the security system 110 has trained the first classifier head 212a on feedback provided solely or primarily on images depicting that particular environment. The application of the first classifier head 212a rather than other classifier heads is shown through a solid line going from the object detection model 211 to the classifier head 212a and to the client device 130. The dashed lines from the object detection model 211 to the other classifier heads (e.g., heads 212b and 212c) indicate that the other classifier heads were not applied to the output of the object detection model 211 or that the output from those other classifier heads are not transmitted to the client device 130.

In one example of the process 300, the image data 310 depicts an image of an individual obscured by trees and an object detection model of the object detection model(s) 211 is configured to detect firearms. The security system 110 is configured to determine whether the individual depicted is carrying a firearm and thus, a potential safety threat. The object detection model 211 receives 301 the image data 310 and determines that a firearm is detected in the image data 310. The output of the object detection model 211 is transmitted 302 to the classifier head 212a in response to the detection engine 210 determining that the classifier head 212a has been trained on images of firearms in a forest environment and that the sensor that provided the image data 310 is located in a forest.

The first classifier head 212a determines whether the output of the object detection model 211 correctly classified a firearm as being in the image data 310. In response to determining that the output meets a threshold accuracy for being classified correctly, the detection engine 210 transmits 303 the output of the object detection model 211 to a client device of the client device(s) 130. A user of the client device may determine that the output did not depict a firearm and thus, the security system 110 had provided a false positive detection. The security system 110 may receive 304 feedback from the user's client device indicating that no firearm is depicted in the image data 310. The training engine 220 labels the image data 310 or the output of the object detection model 211 according to the user's feedback. The training engine 220 thus creates a negative example.

The training engine 220 may use the negative example to re-train the first classifier head 212a, which incorrectly determined that the output of the object detection model 211 was accurate, in substantially real time after creating the negative example. For example, within a minute of adding the negative example to the database 230, the training engine 220 may re-train the classifier head 212a such that subsequent classifications by the classifier head 212a may increase in accuracy. The training engine 220 may continue to create new training data and re-train one or more of the classifier heads 212 as new image data applied to the object detection model 211 and user feedback on the accuracy of the detections are received. This incremental, iterative training allows for the output of the detection engine 210 to improve its accuracy more frequently than conventional systems that would wait to re-train the object detection model 211 after gathering sufficient training data.

The training engine 220 determines when to re-train the object detection model 211. For example, after determining that the image data 310 transmitted 303 was inaccurate based on the user feedback, the training engine 220 may determine to wait to re-train the object detection model 211. The training engine 220 may store the labeled image data 310 as a negative example for re-training the object detection model. In response to a successful object detection that is reported to the user who does not provide negative feedback (e.g., clears a notification asking if the output is a false positive) or provides positive feedback (e.g., provides a “thumbs up” on a notification generated on a GUI by the GUI engine 240), the training engine 220 may label the corresponding image data depicting a firearm as a positive example and determine whether the classifier head 212a has met a metric that triggers re-training the object detection model 211. For example, the training engine 220 may determine that the classifier head 212a has correctly classified at least 90% of the last one hundred detections as accurate and in response, the training engine 220 determines to re-train the object detection model 211.

FIG. 4 depicts GUIs 400a and 400b that include notifications generated by the security system 110 of FIG. 1, in accordance with one embodiment. The GUIs 400a and 400b can be generated by the GUI engine 420. A notification generated by the GUI engine 420 may include a request for user feedback. The GUIs 400a and 400b may include additional, fewer, or different graphical display elements (e.g., buttons, scroller bars, tabs, text boxes, etc.). The GUIs 400a and 400b may be displayed at the client device(s) 130.

The GUI 400a depicts alert notifications 401, 402, and 403. The notifications 401 and 403 include buttons for providing feedback to the security system 110. In particular, a button 411 provides, when selected, feedback to the security system 110 that the detection of a person in the image taken by Camera Bravo was inaccurate (e.g., there was no person in the image or video). A button 412 provides, when selected, feedback to the security system 110 that the detection of the person in the image was accurate. The notification 402 includes buttons for instructing the security system 110 to use a particular data point for re-training one or more of an object detection model or a classifier head. In particular, a button 413 instructs, when selected, the security system 110 to omit the possible animal detection as a data point for re-training and a button 414 instructs, when selected, the security system 110 to include the data point for re-training.

The GUI 400b depicts an updated interface to the GUI 400a after the user has interacted with the alert notification 402. The GUI engine 420 may cause the GUI 400b to be displayed after receiving a user selection of the button 413 or the button 414, which can cause the GUI engine 420 to clear the alert notification 402 and display the alert notification 402 under a “Cleared Alerts” section of the GUI 400b.

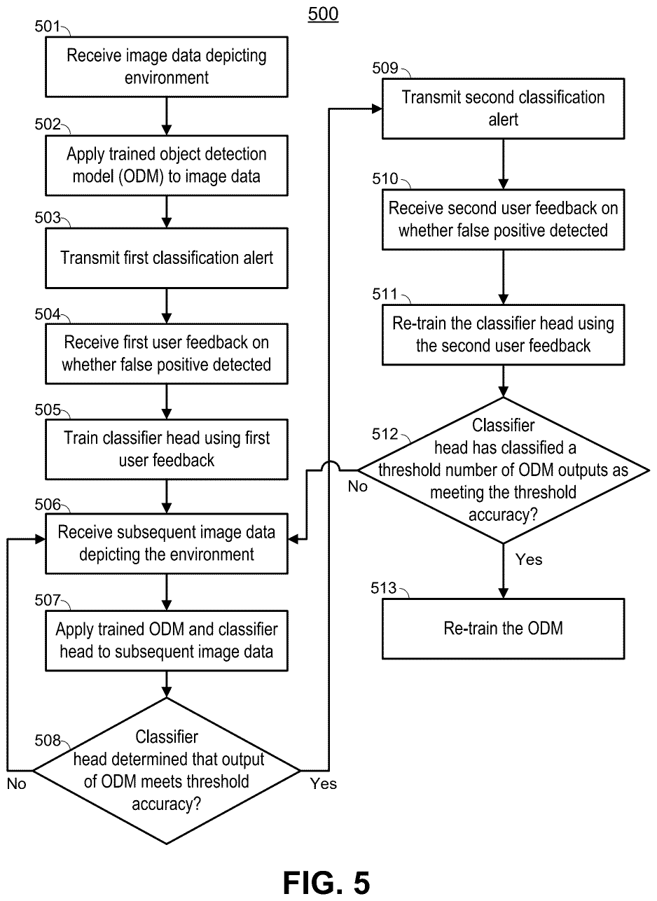

FIG. 5 depicts a flowchart of a process 500 for re-training machine learning models of the security system 110 of FIG. 1, in accordance with one embodiment. Operations of the process 500 may be performed by the security system 110. The process 500 may include additional, fewer, or different operations than shown in FIG. 5. Operations of the process 500 may be performed in a different order than shown in FIG. 5 (e.g., in parallel rather than in series).

The security system 110 receives 501 image data depicting an environment. In one example, the environment may depict an aircraft. The security system 110 applies 502 a trained object detection model to the image data. The object detection model may be trained to detect aircrafts in images or videos. The object detection model may determine that the image data does depict an aircraft. The security system 110 transmits 503 a first classification alert to a client device. The first classification alert may specify that there is an aircraft in the image.

The security system 110 receives 504 a first user feedback on whether a false positive was detected. The first user feedback may indicate that there was no false positive detected because the user can confirm that an aircraft is indeed depicted in the received 501 image data. The security system 110 trains 505 a classifier head using the first user feedback. The security system 110 labels the output of the object detection model as accurate and can train the classifier head using the labeled output. In some embodiments, the training engine 220 of the security system 110 may initiate training of a classifier head in response to determining a threshold amount of user feedback has been obtained to train the classifier head.

The security system 110 receives 506 subsequent image data depicting the environment. For example, the security system 110 can receive 506 another image from the same sensor that captured the received 501 image data. This subsequent image data may not depict an aircraft (e.g., a goose flying in the distance may appear aircraft-like in the image data). The security system 110 applies 507 the trained object detection model and classifier head to the subsequent image data. The object detection model may mistake a goose depicted in the subsequent image data for an aircraft and output that an aircraft was detected. The security system 110 determines 508 whether the classifier head determined that the output of the object detection model met a threshold accuracy. The classifier head may determine that the detection of the goose as an aircraft does not meet the threshold accuracy and in response, return to receiving 506 a subsequent image data depicting the environment.

Continuing the previous example, after receiving yet another image and determining, using the classifier head, that the image does meet the threshold accuracy, the security system 110 transmits 509 a second classification alert to the client device in response to determining 508 that the classifier head determined that the output of the object detection model met the threshold accuracy. The transmitted 509 alert may be displayed on a GUI generated by the GUI engine 240 (e.g., as shown in FIG. 4). The security system 110 receives 510 a second user feedback on whether a false positive was detected. For example, in an instance where the classifier head incorrectly determined that the image of the goose met the threshold accuracy, the security system 110 may receive the user's feedback that the goose was incorrectly identified as a plane. The security system 110 may receive 510 a second user feedback indicating that another image of an aircraft was correctly classified by the detection engine 210 as depicting an aircraft.

The security system 110 re-trains 511 the classifier head using the second user feedback. The security system 110 can re-train 511 the classifier head in substantially real time (e.g., within a minute of receiving the user feedback). Decreasing time intervals between re-training the classifier head may increase the likelihood that the classifier is accurately classifying the output of the object detection model 211. Conventional systems where the time in between re-training machine learning models is longer may cause those machine learning models to be inaccurate for that interval of time. The security system 110 determines 512 whether the classifier head has classified a threshold number of object detection model outputs as meeting the threshold accuracy. For example, the security system 110 determines 512 that the classifier head has classified at least twenty consecutive object detection model 211 outputs as being accurate and each of those outputs were confirmed by the user as also being accurate. In response to the determination 512, the security system re-trains 513 the object detection model. If the security system 110 determines 512 that the classifier head has not met the metric for accurate classification, the security system 110 may return to receiving 506 a subsequent image data and the remaining operations of the process 500 until the metric is met for re-training 513 the object detection model 211.

### Computing Machine Architecture

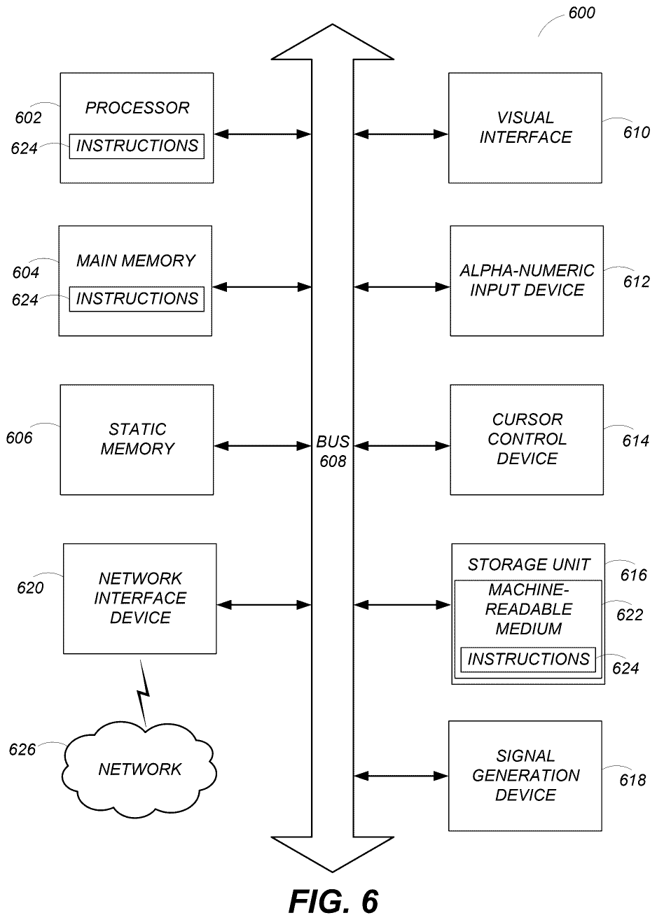

FIG. 6 is a block diagram illustrating components of an example machine able to read instructions from a machine-readable medium and execute them in a processor (or controller). Specifically, FIG. 6 shows a diagrammatic representation of a machine in the example form of a computer system 600 within which program code (e.g., software) for causing the machine to perform any one or more of the methodologies discussed herein may be executed. The program code may be comprised of instructions 624 executable by one or more processors 602. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 600 includes a processor 602 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include visual display interface 610. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 610 may include or may interface with a touch enabled screen. The computer system 600 may also include alphanumeric input device 612 (e.g., a keyboard or touch screen keyboard), a cursor control device 614 (e.g., a mouse, a trackball, a joystick, a motion sensor, or other pointing instrument), a storage unit 616, a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

### Benefits and Additional Considerations

The security system improves the accuracy of machine learning-driven object detection and in turn, decreases the risk of safety threats to individuals or property. The security system leverages classifier heads to improve the accuracy of the overall detection in smaller and more frequent increments. Re-training a classifier head is less processing intensive and time consuming than re-training an object detection machine learning model. The security system can also implement multiple classifier heads, where each classifier head is trained on user feedback for a particular context in which detection occurs (e.g., using a particular sensor, images depicting a particular environment, etc.). The combination of the object detection model and the classifier head can thus produce an accurate object detection that is customized to various contexts in which detection is needed. Furthermore, the security system may implement two or more classifier heads, providing further customized object detection and improved accuracy for that customized detection.

The security system can increase the accuracy of the re-trained machine learning model by initiating the re-training with the last best weights as determined during runtime accuracy evaluations of the machine learning model's output. Using the last best weights may result in a more accurate machine learning model than using the initial weights used to re-train the machine learning model. Having a more accurate model, the security system may determine to re-train the machine learning model less frequently and thus, reduce processing resources that conventional systems would need to expend to re-train less accurate models.

The security system minimizes information leakage when applying classifier heads by implementing hardware-aware training when training the classifier heads. By selecting one of a full-precision, half-precision, mixed-precision, or any other suitable variant of machine learning model training technique based on the type of hardware on which the trained machine learning model will run, the security system trains a model whose accuracy is sufficient for the hardware that the model is executed on. For example, the security system will avoid training a classifier head using full precision when the device that the classifier head is to be executed on does not implement the same high degree of accuracy and would otherwise result in information leakage with the over-performing computational accuracy of the classifier head.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Throughout this specification, some embodiments have used the expression “coupled” along with its derivatives. The term “coupled” is not necessarily limited to two or more elements being in direct physical or electrical contact. Rather, the term “coupled” may also encompass two or more elements that are not in direct contact with each other, but yet still co-operate or interact with each other.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where values are described as “approximate” or “substantially” (or their derivatives), such values should be construed as accurate+/−10% unless another meaning is apparent from the context. From example, “approximately ten” should be understood to mean “in a range from nine to eleven.”

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability. Any computing systems including multiple processors may operate the multiple processors individually or collectively.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the disclosed subject matter. It is therefore intended that the scope be limited not by this detailed description, but rather by any claims that issue on an application based hereon. Accordingly, the disclosure of the embodiments are intended to be illustrative, but not limiting, of the scope, which is set forth in the following claims.

What is claimed is:

1. A non-transitory computer-readable storage medium comprising stored instructions, the instructions when executed by a computing system cause the computing system to:
receive, from a client device, a first user feedback indicating an accuracy of a first output of an object detection model, the object detection model trained to detect an object within a given image received from a sensor, the first output associated with a first input image;
train a classifier head using the first user feedback, the classifier head configured to determine a likelihood that a given output of the object detection model meets a threshold accuracy;
in response to determining, using the classifier head, that a second output of the object detection model meets the threshold accuracy, cause a notification to be generated at the client device, the notification including a request for a second user feedback indicating an accuracy of the second output associated with a second input image;
re-train the classifier head using the second user feedback; and
in response to determining that the classifier head has classified a threshold number of the object detection model outputs as meeting the threshold accuracy, re-train the object detection model using image data labeled based on a plurality of user feedback, the image data received from the sensor.

2. The non-transitory computer-readable storage medium of claim 1, wherein the instructions further comprise instructions that when executed by the computing system cause the computing system to:
receive a hardware identifier of the client device; and
determine, based on the hardware identifier, one of a full precision training, half precision training, or mixed precision training to train the classifier head.

3. The non-transitory computer-readable storage medium of claim 1, wherein the instructions further comprise instructions that when executed by the computing system cause the computing system to:
train a plurality of classifier heads based on respective hardware identifiers of a plurality of client devices, wherein the plurality of classifier heads includes the classifier head.

4. The non-transitory computer-readable storage medium of claim 1, wherein the instructions further comprise instructions that when executed by the computing system cause the computing system to:
train the object detection model using a first set of weights associated with a predefined training dataset; and
determine a second set of weights associated with an updated training dataset, the updated training dataset including image data for which user feedback on the accuracy of the object detection model was received.

5. The non-transitory computer-readable storage medium of claim 1, wherein the instructions further comprise instructions that when executed by the computing system cause the computing system to:
in response to determining that a third output of the object detection model does not meet the threshold accuracy, store the third output without generating another notification, wherein the third output is stored with a label indicating the object was not detected in a third input image.

6. The non-transitory computer-readable storage medium of claim 1, wherein the threshold accuracy is associated with a context parameter characterizing one or more images input to the object detection model or user feedback of the output of the object detection model, wherein a context parameter is one or more of a type of client device, an environment type depicted in the images input into the object detection model, or a client application for which the output of the object detection model is used.

7. The non-transitory computer-readable storage medium of claim 1, wherein the classifier head is automatically re-trained in response to receiving user feedback indicating the accuracy of the object detection model.

8. A computer system comprising:
a training engine configured to:
receive, from a client device, a first user feedback indicating an accuracy of a first output of an object detection model, the object detection model trained to detect an object within a given image received from a sensor, the first output associated with a first input image,
train a classifier head using the first user feedback, the classifier head configured to determine a likelihood that a given output of the object detection model meets a threshold accuracy,
re-train the classifier head using a second user feedback indicating an accuracy of a second output of the object detection model associated with a second input image, and
in response to determining that the classifier head has classified a threshold number of the object detection model outputs as meeting the threshold accuracy, re-train the object detection model using image data labeled based on a plurality of user feedback, the image data received from the sensor; and
a detection engine configured to:
in response to determining, using the classifier head, that the second output meets the threshold accuracy, cause a notification to be generated at the client device, the notification including a request for the second user feedback.

9. The computer system of claim 8, wherein the training engine is further configured to:
receive a hardware identifier of the client device; and
determine, based on the hardware identifier, one of a full precision training, half precision training, or mixed precision training to train the classifier head.

10. The computer system of claim 8, wherein the training engine is further configured to:
train a plurality of classifier heads based on respective hardware identifiers of a plurality of client devices, wherein the plurality of classifier heads includes the classifier head.

11. The computer system of claim 8, wherein the training engine is further configured to:
train the object detection model using a first set of weights associated with a predefined training dataset; and
determine a second set of weights associated with an updated training dataset, the updated training dataset including image data for which user feedback on the accuracy of the object detection model was received.

12. The computer system of claim 8, wherein the detection engine is further configured to:
in response to determining that a third output of the object detection model does not meet the threshold accuracy, store the third output without generating another notification, wherein the third output is stored with a label indicating the object was not detected in a third input image.

13. The computer system of claim 8, wherein the threshold accuracy is associated with a context parameter characterizing one or more of images input to the object detection model or user feedback of the output of the object detection model, wherein a context parameter is one or more of a type of client device, an environment type depicted in the images input into the object detection model, or a client application for which the output of the object detection model is used.

14. The computer system of claim 8, wherein the classifier head is automatically re-trained in response to receiving user feedback indicating the accuracy of the object detection model.

15. A method comprising:
receiving, from a client device, a first user feedback indicating an accuracy of a first output of an object detection model, the object detection model trained to detect an object within a given image received from a sensor, the first output associated with a first input image;
training a classifier head using the first user feedback, the classifier head configured to determine a likelihood that a given output of the object detection model meets a threshold accuracy;
in response to determining, using the classifier head, that a second output of the object detection model meets the threshold accuracy, causing a notification to be generated at the client device, the notification including a request for a second user feedback indicating an accuracy of the second output associated with a second input image;
re-training the classifier head using the second user feedback; and
in response to determining that the classifier head has classified a threshold number of the object detection model outputs as meeting the threshold accuracy, re-training the object detection model using image data labeled based on a plurality of user feedback, the image data received from the sensor.

16. The method of claim 15, further comprising:
identifying a hardware identifier of the client device; and
determining, based on the hardware identifier, one of a full precision training, half precision training, or mixed precision training to train the classifier head.

17. The method of claim 15, further comprising:
training a plurality of classifier heads based on respective hardware identifiers of a plurality of client devices, wherein the plurality of classifier heads includes the classifier head.

18. The method of claim 15, further comprising:
training the object detection model using a first set of weights associated with a predefined training dataset; and
determining a second set of weights associated with an updated training dataset, the updated training dataset including image data for which user feedback on the accuracy of the object detection model was received.

19. The method of claim 15, further comprising:
in response to determining that a third output of the object detection model does not meet the threshold accuracy, storing the third output without generating another notification, wherein the third output is stored with a label indicating the object was not detected in a third input image.

20. The method of claim 15, wherein the threshold accuracy is associated with a context parameter characterizing one or more of images input to the object detection model or user feedback of the output of the object detection model, wherein a context parameter is one or more of a type of client device, an environment type depicted in the images input into the object detection model, or a client application for which the output of the object detection model is used.
